(19) United States
(12) Patent Application Publication
(10) Pub. No.: US 2023/0212904 A1
(43) Pub. Date: Jul. 6, 2023

(54) Touchless Frunk Release and Directional Frunk Sensor Array System

(71) Applicant: Akash Ladha, Farmington Hills, MI (US)

(72) Inventor: Akash Ladha, Farmington Hills, MI (US)

(21) Appl. No.: 17/567,931

(22) Filed: Jan. 4, 2022

(51) Int. Cl. E05F 15/73; E05F 15/40

(52) U.S. Cl. CPC E05F 15/73; E05F 15/40; E05F 2015/767; E05Y 2201/41; E05Y 2201/422; E05Y 2400/612; E05Y 2400/822; E05Y 2400/86; E05Y 2400/54; E05Y 2900/536

(57) ABSTRACT

The present disclosure provides a smart automated latch mechanism for opening a front trunk of a vehicle and a smart sensor array for detecting when the front trunk of the vehicle is at capacity. The system operates by having an electronic latch mechanism for the front trunk coupled with an infra-red sensor at the interface between the lid and the vehicle bonnet. When a change in temperature is detected in this space by the sensor, an electric motor causes the front trunk to open, removing the need for the user to actually touch the vehicle to open the front trunk. This system combines with a directional sensor array arranged inside the trunk which detects when an object is placed in front of it. The sensor array is arranged at a capacity height of the trunk, and thus allows for automated detection of when an object is in an inappropriate position, preventing damage to the vehicle from closing the front trunk lid on the object.

### FIELD OF INVENTION

The present invention relates generally to smart vehicle systems. More specifically, the present invention relates to an automated system for touchless frunk release and for detecting obstruction of a frunk lid closure.

### BACKGROUND

Frunks, or front trunks, are becoming increasingly popular in smart vehicles as an easily accessible space for storing luggage.

While frunks are usually implemented in smart vehicles, they are in general still opened and closed manually. This often involves the driver actuating an internally placed release mechanism which undoes a locking latch on the hood of the car, and then walking around to the front and attempting to find a mechanical lever for raising the unlocked hood underneath the hood by touch alone. The area is often dirty and without line of sight it can take the user some time to find the lever and raise the lid.

Another problem with current frunk technology is that there is no mechanism for detecting when the frunk has been filled over capacity. A user may overfill the frunk and damage either the hood of the car or the possessions they have stored in the frunk that are protruding out of it.

Such issues can also cause the re-locking of the frunk to fail, since the hood is prevented form fully re-engaging with the latch mechanism that locks the hood in place during transit. With current frunk technology, the user would have to walk back to the driver's seat to actuate the internal release mechanism again before attempting to close the hood once more.

It is within this context that the present invention is provided.

### SUMMARY

The present disclosure provides a smart automated latch mechanism for opening a front trunk of a vehicle and a smart sensor array for detecting when the front trunk of the vehicle is at capacity.

The system operates by having an electronic latch mechanism for the front trunk coupled with an infra-red sensor at the interface between the lid and the vehicle bonnet. When a change in temperature is detected in this space by the sensor, an electric motor causes the front trunk to open, removing the need for the user to actually touch the vehicle to open the front trunk. This system combines with a directional sensor array arranged inside the trunk which detects when an object is placed in front of it. The sensor array is arranged at a capacity height of the trunk, and thus allows for automated detection of when an object is in an inappropriate position, preventing damage to the vehicle from closing the front trunk lid on the object.

Thus, according to one aspect of the present disclosure there is provided a smart front trunk latch and sensor system, comprising: an electronic latch mechanism configured to lock or unlock a front trunk lid of a vehicle; an motion sensor coupled to the electronic latch mechanism; an electric motor configured to move the front trunk lid between an open and closed position; an IR sensor array disposed within the front trunk and aligned directionally parallel to one another along a horizontal direction at a full capacity height of the front trunk; one or more warning lights or speakers; and a controller.

The controller is configured to interface with a vehicle controller system and perform the following steps: determine that an internal front trunk release mechanism of the vehicle has been actuated; receive a signal detection indicating a hand has been placed between the front trunk lid and the motion sensor; cause the latch mechanism to release and the electric motor to raise the front trunk lid to an open position; and if an obstruction is sensed by the IR sensor array, activate one or more warning lights an/or sound an alarm on one or more speakers.

In some embodiments, each of the electronic components of the system are coupled to and derive power from the vehicle battery.

In some embodiments, the system further comprises one or more externally disposed sensors, and the controller is further configured to cause the latch mechanism to release and the electric motor to raise the front trunk lid to an open position in response to a detection from the one or more external sensors that a person is standing in front of the front trunk.

The externally disposed sensors may be ultrasonic sensors disposed on the corners or front side of the vehicle.

In some embodiments, the system further comprises one or more IR sensors disposed internally to the front trunk, the one or more sensors being configured to detect the presence of a living being.

The controller may be configured to, in response to a detection from the sensor indicating the presence of a living being in the front trunk, unlock the latch mechanism and cause the electric motor to raise the front trunk lid to an open position.

Alternatively, if the vehicle is already moving, the controller may be configured to, in response to a detection from the sensor indicating the presence of a living being in the front trunk, interface with the vehicle controller to limit the vehicle speed to a predetermined threshold speed and display warning lights.

In some embodiments, the motion sensor is an infra-red, IR, sensor.

In some embodiments, the motion sensor is another type of geothermal imaging sensor.

In some embodiments, the controller is configured to operate the electric motor to perform soft opens and closes like a cinch motor.

In some embodiments, the system further comprises a breaking system coupled to the electric motor to resist external forces applied to the front trunk lid and ensure safe opening and closing of the lid.

In some embodiments, the one or more warning lights include red lights disposed about the circumference of the front trunk space.

In some embodiments, the one or more warning lights include a light disposed in a vehicle front logo.

### BRIEF DESCRIPTION OF THE DRAWINGS

Various embodiments of the invention are disclosed in the following detailed description and accompanying drawings.

FIG. 1 illustrates a block diagram of the functional components of an example latch release and sensor array system according to the present disclosure.

FIG. 2 illustrates a cutaway view of an example front trunk of a vehicle incorporating the system according to the present disclosure being operated by a user.

FIG. 3 illustrates an isometric perspective view of an example front trunk configuration incorporating the system according to the present disclosure, with an array of directional IR sensors in operation to prevent overfilling of the front trunk.

FIG. 4 illustrates an isometric perspective view of the example front trunk configuration incorporating the system according to the present disclosure, with the array of directional IR sensors in operation being obstructed by an object protruding out of the front trunk.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

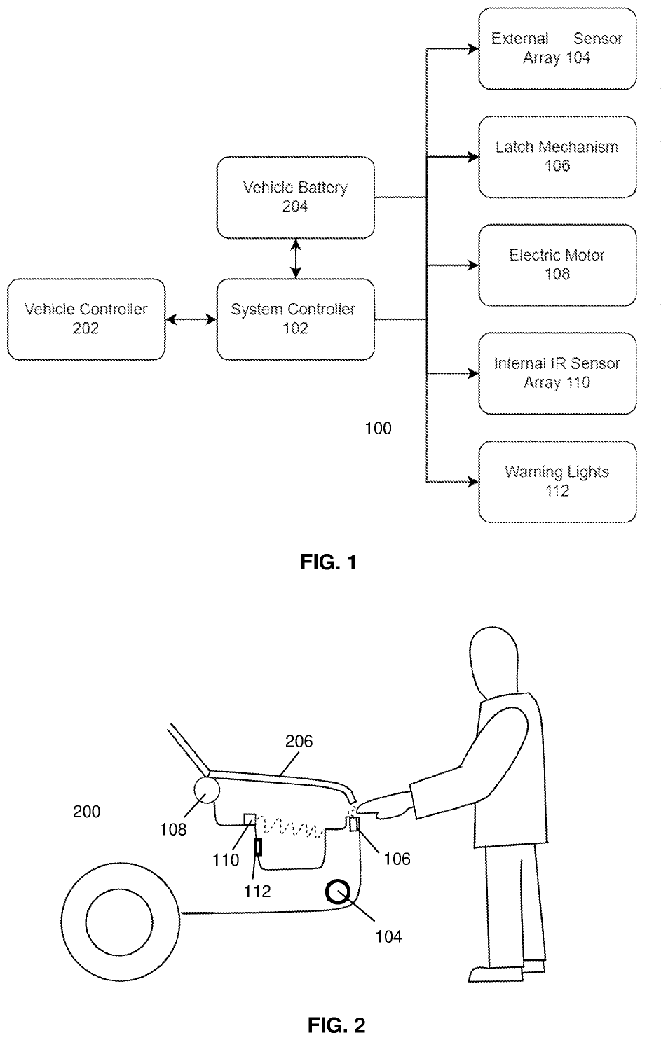

Referring to FIG.1, a block diagram of the functional components of an example latch release and sensor array system 100 according to the present disclosure is shown.

The system is operated by a central control board 102 which controls the operations of the various components and in the present example also interfaces with a vehicle controller 202. The system is generally coupled to and powered by the vehicle power source 204 as shown.

The system itself is comprised of an electronic latch mechanism configured to lock or unlock a front trunk lid of a vehicle. Any suitable type of electrically operated latch locking mechanism can be used as will be understood by those skilled in the art.

The latch mechanism 106 further incorporates a motion sensor, preferably a temperature sensitive sensor such as an infra-red sensor, which is disposed adjacent and coupled to the latch mechanism.

When the hood (i.e. the front trunk lid) of the vehicle is opened—which is usually triggered by a user operating a release lever internal to the vehicle on the driver side—the hood will raise slightly forming a space between the front trunk rim and the hood where a user would normally have to reach in and release a second lever to fully open the hood.

The motion sensor is placed such that a user's hand entering that space will be detected due to a corresponding change in temperature. This detection will trigger the latch mechanism which the motion sensor is coupled to and cause the controller to operate an electric motor 108 to fully open the vehicle hood and expose the front trunk.

Referring to FIG.2, a cutaway view of an example front trunk of a vehicle 200 incorporating the system according to the present disclosure is shown being operated by a user placing their hand in the space between the front trunk rim and the hood of the vehicle 206 to be detected by the motion sensor of the latch mechanism 106 as described.

The system controller 102 is configured to determine that the internal front trunk release mechanism of the vehicle has been actuated; receive a signal detection indicating a hand has been placed between the front trunk lid and the motion sensor of the latch mechanism 106; and cause the latch mechanism 106 to release and the electric motor 108 to raise the front trunk lid to an open position.

Alternatively, or in some cases additionally, there may be an external sensor array 104 incorporated into the system, or which is already a part of a smart vehicle on which the system is installed. These may include for example ultrasonic sensors used to detect objects in front of or underneath the front of the vehicle. The opening of the hood may also be triggered by this sensor array 104 once the internal latch release lever has been actuated.

An IR sensor array 110 is disposed within the front trunk. The array comprises a plurality of IR sensors that are aligned directionally parallel to one another along a horizontal direction. The sensors are each placed in a horizontal line along the rear side of the front trunk rim, and at a height that corresponds to a maximum carrying capacity of the front trunk.

Advantageously, this allows for detection by the system when objects are placed in the front trunk such that they protrude above the maximum capacity line.

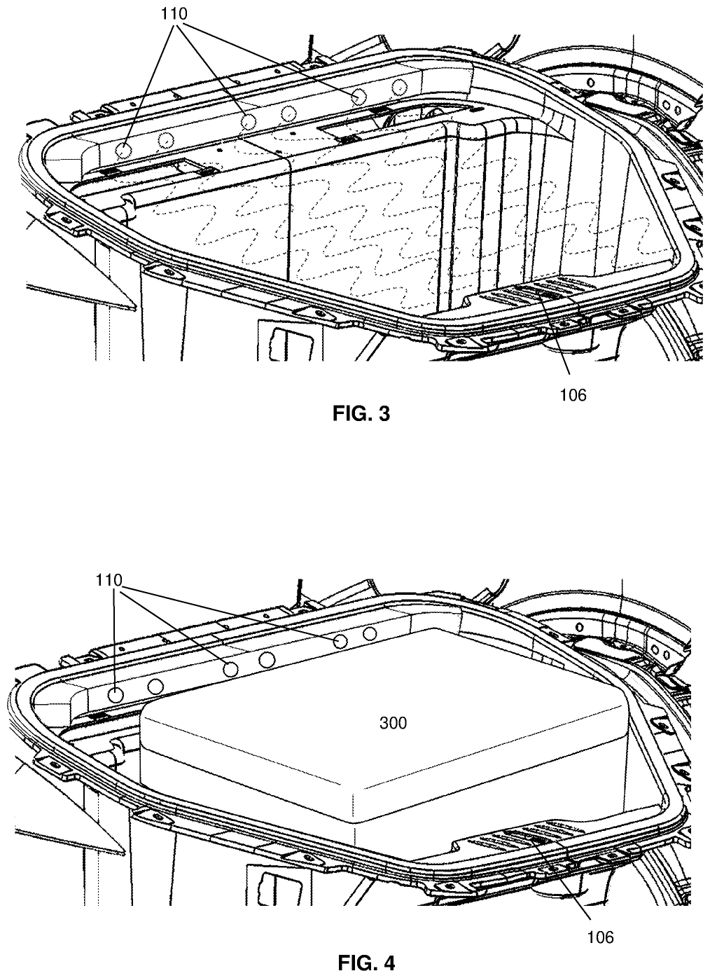

Referring to FIG.3 and FIG.4, isometric perspective views of an example front trunk configuration incorporating the system according to the present disclosure are shown.

FIG.3 shows the array of directional IR sensors 112 in operation to ready to detect obstructions and thus prevent overfilling of the front trunk.

FIG.4 shows the array of directional IR sensors 112 in operation being obstructed by an object 300 protruding out of the front trunk.

If such an obstruction 300 is sensed by the IR sensor array 110, the controller is configured to activate one or more warning lights 112 and/or sound an alarm on one or more speakers of the vehicle. For example, it may cause the vehicle to emit a honking noise. In some examples, the one or more warning lights include red lights disposed about the circumference of the front trunk space, in other examples, the one or more warning lights include a light disposed in a vehicle front logo.

In this manner, the user is warned that closing the front trunk lid will cause it to collide with the object protruding from the front trunk, possibly damaging the hood or the object itself.

In further examples, the electric motor 108 of the system incorporates a breaking system coupled, allowing the electric motor to resist external forces applied to the front trunk lid and ensure safe opening and closing of the lid.

The controller 102 may thus also be configured to, in response to such a detection from the IR sensor array 110, operate the motor 108 to apply a resistive force to closure of the front trunk lid. The controller may also be configured to operate the electric motor 108 to perform soft opens and closes of the front trunk lid in general, like a cinch motor.

The system may further incorporate one or more additional sensors, such as infra-red sensors, internal to the front trunk, for detecting the presence of a living being.

In such examples, the controller 102 may be configured to, in response to a detection from the sensor indicating the presence of a living being in the front trunk, and if the vehicle is not currently moving, automatically unlock the latch mechanism 106 and cause the electric motor 108 to raise the front trunk lid to an open position.

Alternatively, if the vehicle is already moving, the controller 102 may be configured to, in response to a detection from the internal sensors sensor indicating the presence of a living being in the front trunk, interface with the vehicle controller 202 to limit the vehicle speed to a predetermined threshold speed and display warning lights. For example the maximum speed of the vehicle may be reduced to 5 mph to prevent a dangerous collision from occurring while the individual is trapped in the front trunk.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A smart front trunk latch and sensor system, comprising:
an electronic latch mechanism configured to lock or unlock a front trunk lid of a vehicle;
an motion sensor coupled to the electronic latch mechanism;
an electric motor configured to move the front trunk lid between an open and closed position;
an IR sensor array disposed within the front trunk and aligned directionally parallel to one another along a horizontal direction at a full capacity height of the front trunk;
one or more warning lights or speakers; and
a controller, wherein the controller is configured to interface with a vehicle controller system and perform the following steps:
determine that an internal front trunk release mechanism of the vehicle has been actuated;
receive a signal detection indicating a hand has been placed between the front trunk lid and the motion sensor;
cause the latch mechanism to release and the electric motor to raise the front trunk lid to an open position; and
if an obstruction is sensed by the IR sensor array, activate one or more warning lights an/or sound an alarm on one or more speakers.

2. A smart front trunk latch and sensor system according to claim 1, wherein each of the electronic components of the system are coupled to and derive power from the vehicle battery.

3. A smart front trunk latch and sensor system according to claim 1, wherein the system further comprises one or more externally disposed sensors, and the controller is further configured to cause the latch mechanism to release and the electric motor to raise the front trunk lid to an open position in response to a detection from the one or more external sensors that a person is standing in front of the front trunk.

4. A smart front trunk latch and sensor system according to claim 3, wherein the externally disposed sensors are ultrasonic sensors disposed on the corners or front side of the vehicle.

5. A smart front trunk latch and sensor system according to claim 1, wherein the system further comprises one or more IR sensors disposed internally to the front trunk, the one or more sensors being configured to detect the presence of a living being.

6. A smart front trunk latch and sensor system according to claim 5, wherein the controller is configured to, in response to a detection from the sensor indicating the presence of a living being in the front trunk, unlock the latch mechanism and cause the electric motor to raise the front trunk lid to an open position.

7. A smart front trunk latch and sensor system according to claim 5, wherein the controller is configured to, in response to a detection from the sensor indicating the presence of a living being in the front trunk, interface with the vehicle controller to limit the vehicle speed to a predetermined threshold speed and display warning lights.

8. A smart front trunk latch and sensor system according to claim 1, wherein the motion sensor is an infra-red, IR, sensor.

9. A smart front trunk latch and sensor system according to claim 1, wherein the motion sensor is a geothermal imaging sensor.

10. A smart front trunk latch and sensor system according to claim 1, wherein the controller is configured to operate the electric motor to perform soft opens and closes like a cinch motor.

11. A smart front trunk latch and sensor system according to claim 1, wherein the system further comprises a breaking system coupled to the electric motor to resist external forces applied to the front trunk lid and ensure safe opening and closing of the lid.

12. A smart front trunk latch and sensor system according to claim 1, wherein the one or more warning lights include red lights disposed about the circumference of the front trunk space.

13. A smart front trunk latch and sensor system according to claim 1, wherein the one or more warning lights include a light disposed in a vehicle front logo.
